(19) United States
(12) Patent Application Publication
(10) Pub. No.: US 2006/0056201 A1
(43) Pub. Date: Mar. 16, 2006

(54) Backlight modules

(76) Inventors: Chih-Li Chang, Tainan City (TW); Hung-Chen Kao, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/990,878

(22) Filed: Nov. 17, 2004

(30) Foreign Application Priority Data
Sep. 16, 2004 (TW) 93127994

(51) Int. Cl. F21V 7/04

(52) U.S. Cl. 362/631

(57) ABSTRACT

Backlight modules are provided. The backlight module includes a printed circuit board, a plurality of red light emitting diode, a plurality of blue light emitting diode, a plurality of green light emitting diode and a plurality of white light emitting diode. The plurality of red, blue, green and white light emitting diodes are disposed on the printed circuit board, defining a light emitting area. The plurality of white light emitting diodes is disposed at the periphery of the light emitting area.

### BACKGROUND

The invention relates to backlight modules and more particularly, to backlight modules utilizing light emitting diodes as light sources.

A conventional backlight module typically utilizes a cold cathode fluorescent lamp as a light source. Cold cathode fluorescent lamps, however, contains environmentally hazardous mercury.

Other conventional backlight modules utilize light emitting diodes (LEDs) as a light source, as shown in FIG. 1A. The backlight module includes a light source 12, a reflector 13, a diffuser 14 and a reflecting frame 15. The light source 12 comprises red, blue and green LEDs encircling the reflector 13. The lights emitted by red, blue and green LEDs are blended to white light, reflected and diffused by the reflector 13, diffuser 14 and reflecting frame 15 to form a planar light emitting surface. Some problems, however, occur at the corner and periphery of the conventional backlight module. Referring to FIG. 1B showing a corner of the conventional backlight module according to FIG. 1A, no LED is disposed at a first position I, a red LED is disposed at a second position II, a green LED is disposed at a third position III, and a blue LED is disposed at a fourth position IV. A red and a blue LEDs are disposed adjacent to the green LED which is disposed at the third position III, such that the blended light around the third position III is uniform. The red LED which is disposed at the second position II, however, stands alone as no LED is placed at the first position I. Thus, the blended light near the first and second positions I and II is non-uniform. In other words, a chromatic aberration occurs at the corner and periphery of a conventional backlight module. One method of solving the problem is to cover these portions. This, however, reduces the overall display area.

Another small size backlight module utilizes white LEDs as a light source. The white light emitted by the white LED, however, is not as good as the white light blended from the red, blue and green LEDs. Thus, white LEDs are not utilized in large size backlight modules.

### SUMMARY

Backlight modules are provided. An exemplary embodiment of a backlight module comprises a printed circuit board, a red light emitting diode, a blue light emitting diode, a green light emitting diode and a white light emitting diode. The red, blue, green and white light emitting diodes (LEDs) are disposed on the printed circuit board.

Some embodiments of a backlight module comprise a printed circuit board, a plurality of red LEDs, a plurality of blue LEDs, a plurality of green LEDs and a plurality of white LEDs. The plurality of red, blue, green and white LEDs are disposed on the printed circuit board, defining a light emitting area, the plurality of white LEDs is disposed at the periphery of the light emitting area.

### DESCRIPTION OF THE DRAWINGS

FIG. 1A is a schematic diagram of a conventional backlight module;

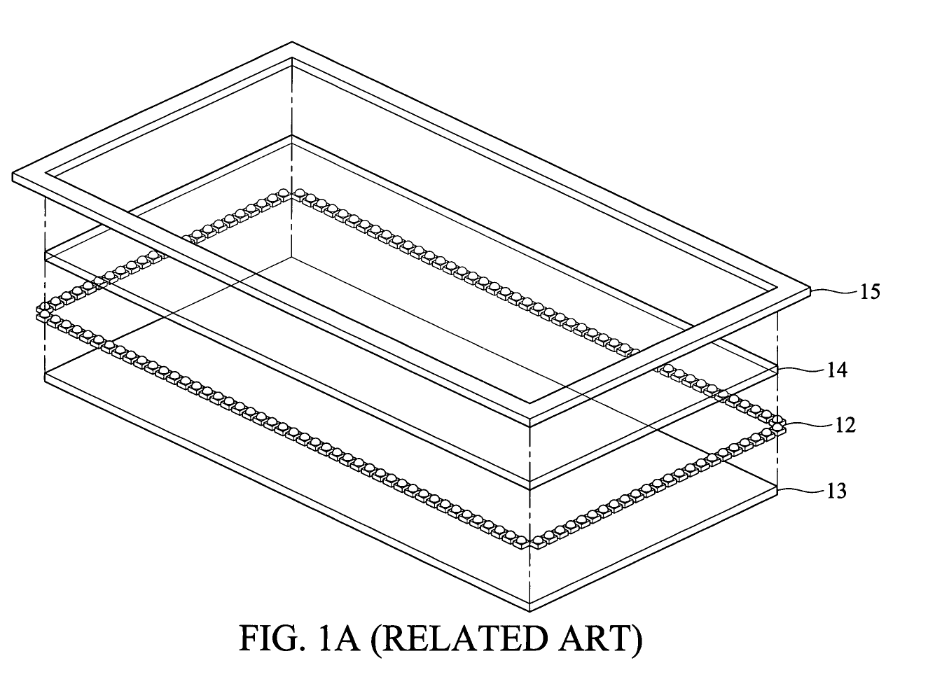

FIG. 1B is a partial enlarged view of the backlight module according to FIG. 1A;

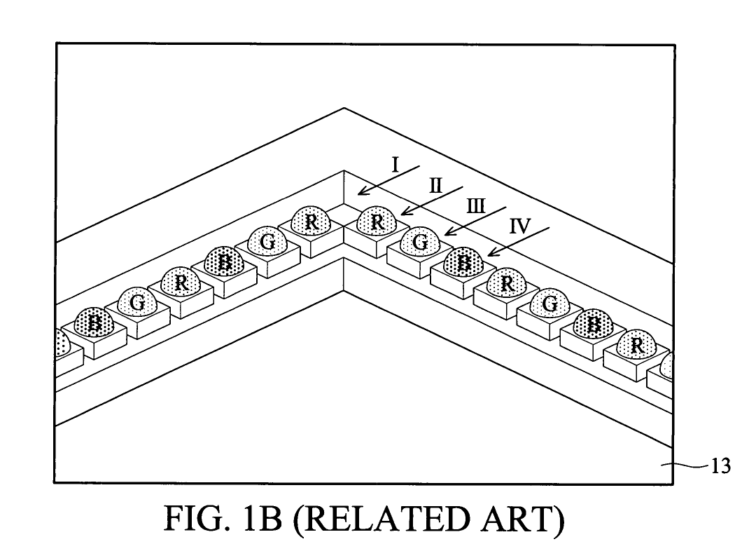

FIG. 2 is a schematic diagram illustrating a backlight module according to an embodiment of the present invention;

FIG. 3A is a partial enlarged view illustrating a backlight module according to an embodiment of the present invention;

FIG. 3B is a schematic diagram illustrating a backlight module according to an embodiment of the present invention;

FIG. 4A is a partial enlarged view illustrating a backlight module according to an embodiment of the present invention;

FIG. 4B is a schematic diagram illustrating a backlight module according to an embodiment of the present invention;

FIG. 5A is a partial enlarged view illustrating a backlight module according to an embodiment of the present invention;

FIG. 5B is a schematic diagram illustrating a backlight module according to an embodiment of the present invention;

FIG. 6A is a schematic diagram illustrating a backlight module according to an embodiment of the present invention;

FIG. 6B is a schematic diagram illustrating a backlight module according to an embodiment of the present invention;

FIG. 7 is a schematic diagram illustrating a backlight module according to an embodiment of the present invention;

FIG. 8 is a schematic diagram illustrating a backlight module according to an embodiment of the present invention; and

FIG. 9 is a schematic diagram illustrating a backlight module according to an embodiment of the present invention.

### DETAILED DESCRIPTION

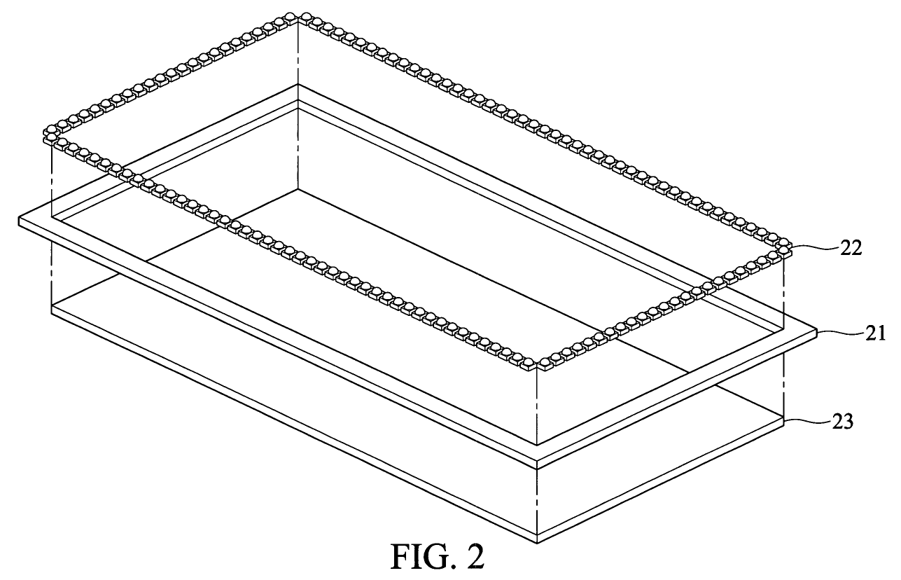

Backlight modules are provided. An exemplary embodiment of a backlight module comprises a printed circuit board 21, a light source 22 and a reflector 23, as shown in FIG. 2. The light source 22 comprises a red light emitting diode (LED) R, a blue LED B, a green LED G and a white LED W. The red, blue, green and white LEDs R, B, G and W are disposed on the printed circuit board 21 which is disposed on the reflector 23. The reflector 23 reflects light emitted by the red, blue, green and white LEDs R, B, G and W in conjunction with a diffuser (not shown) to form a planar light emitting surface.

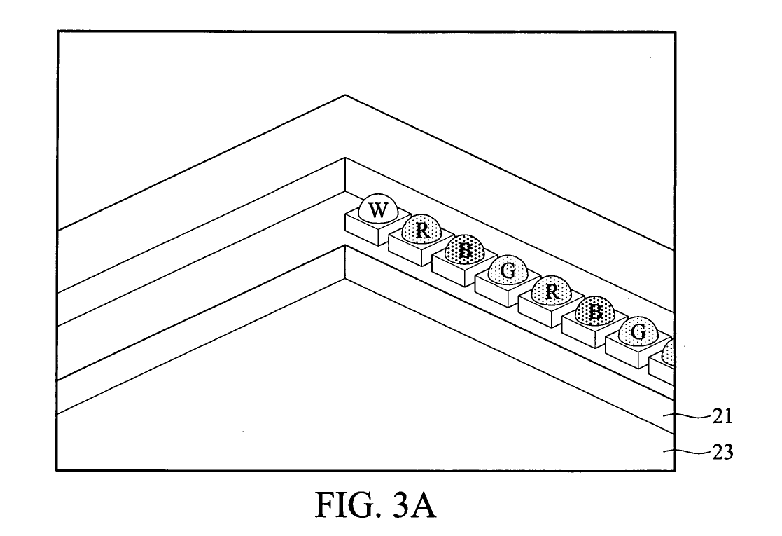

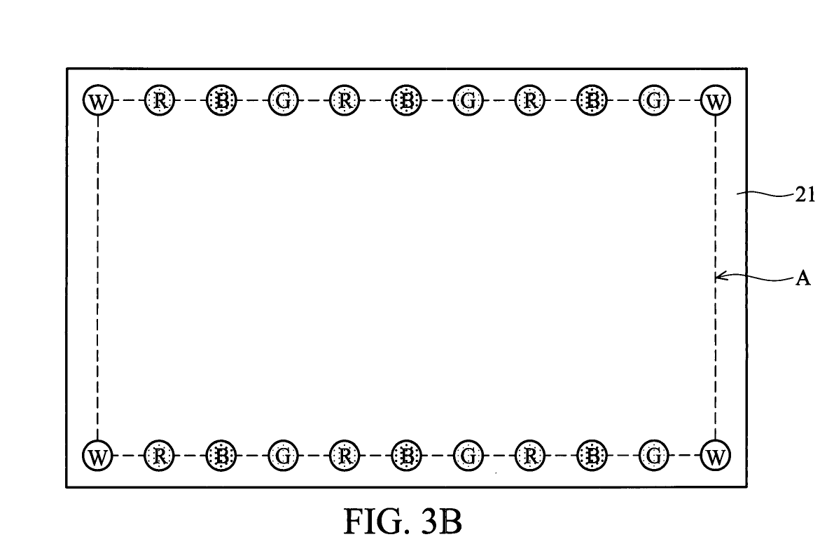

FIG. 3A is a partial enlarged view and FIG. 3B is a schematic diagram of an embodiment of a backlight module. In FIGS. 3A and 3B, the backlight module is an edge type backlight module, comprising a printed circuit board 21, a light source and a reflector 23. The light source is constructed by red LEDs R, blue LEDs B, green LEDs G and white LEDs W.

Referring to FIG. 3B, the red, blue, green and white LEDs R, B, G and W are disposed along a line and at two opposite edges of the printed circuit board 21, defining a rectangular light emitting area A. The white LEDs W are disposed at corners of the light emitting area A. In other words, when stands at one mentioned line on the edge of the printed circuit board 21 (the other line is the same), the white LEDs W are disposed at two end of the line. Referring back to FIG. 3A, the white LEDs W are disposed at corners or periphery of the backlight module to solve the chromatic aberration problem occurred at the conventional backlight module.

In some embodiments, number of the red, blue and green LEDs R, B and G may be the same. When the number differs, causing chromatic aberrations, white LEDs are employed to increase chromatic uniformity. Moreover, the collocation of the LEDs is not limited the arrangement depicted in figure.

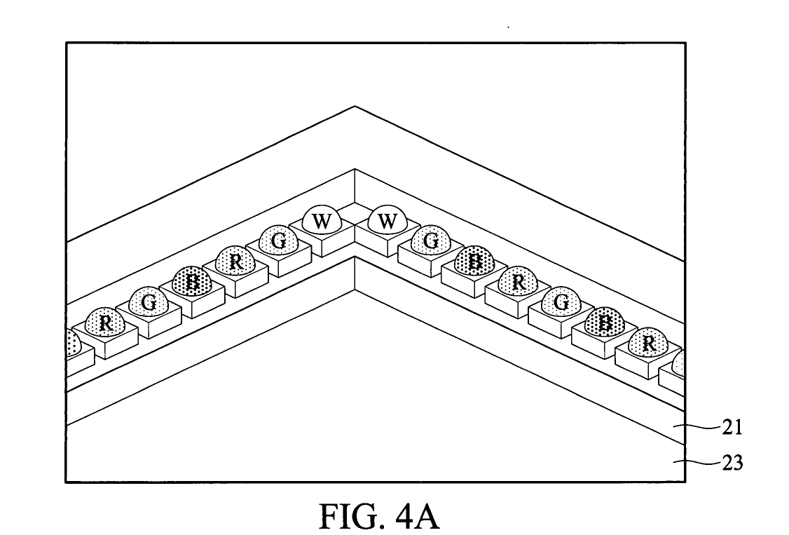

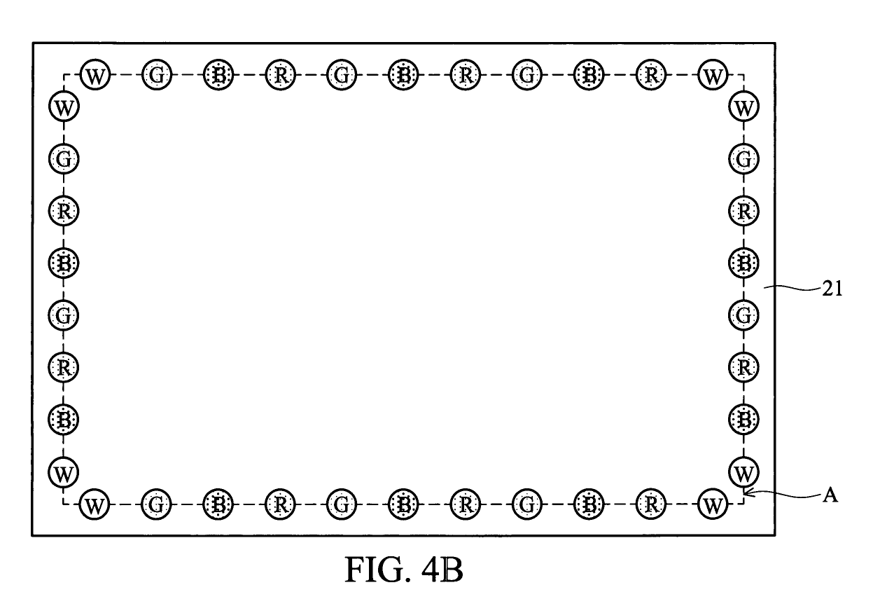

FIG. 4A is a partial enlarged view and FIG. 4B is a schematic diagram of an embodiment of a backlight module. In FIGS. 4A and 4B, the backlight module is an edge type backlight module. Descriptions of elements using the same reference numbers are omitted.

The red, blue, green and white LEDs R, B, G and W are disposed at the periphery of the printed circuit board 21, for example, respectively aligned on four edges of the printed circuit board 21, defining a rectangular light emitting area A. The white LEDs W are disposed at the corners of the light emitting area A. In other words, when viewing only one edge of the printed circuit board 21, which is identical to the other edges, the white LEDs W are disposed at each end of each edge.

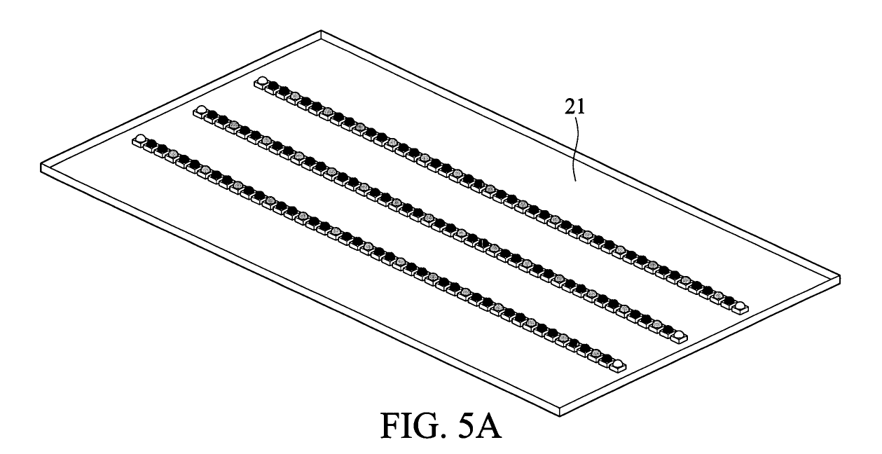

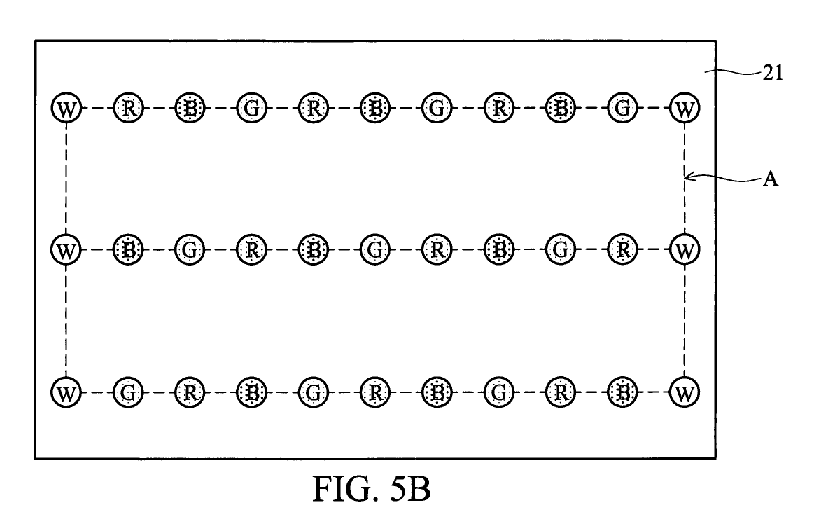

FIGS. 5A and 5B are schematic diagrams of an embodiment of a backlight module. In FIGS. 5A and 5B, the backlight module is a direct type backlight module, comprising a printed circuit board 21 and a light source. The light source comprises red LEDs (LEDs) R, blue LEDs B, green LEDs G and white LEDs W.

The red, blue, green and white LEDs R, B, G and W are disposed on the printed circuit board 21, along three lines (the number of the lines is not limited), defining a rectangular light emitting area A. The white LEDs W are disposed at the corners or periphery of the light emitting area A. In other words, when viewing only one mentioned line on the printed circuit board 21, which is identical to the other two lines, the white LEDs W are disposed at each end of each line.

In some embodiments, in the light emitting area A, the red, blue, and green LEDs R, B and G are alternately arranged. Namely, the two adjacent LEDs have different colors, such that the blended light can be more uniformly. The columns and rows of the LEDs may vary according to requirements.

In some embodiments, number of the red, blue and green LEDs R, B and G may be the same. When the number differs, causing chromatic aberrations, white LEDs are employed to increase chromatic uniformity. Moreover, the collocation of the LEDs is not limited the arrangement depicted in figure.

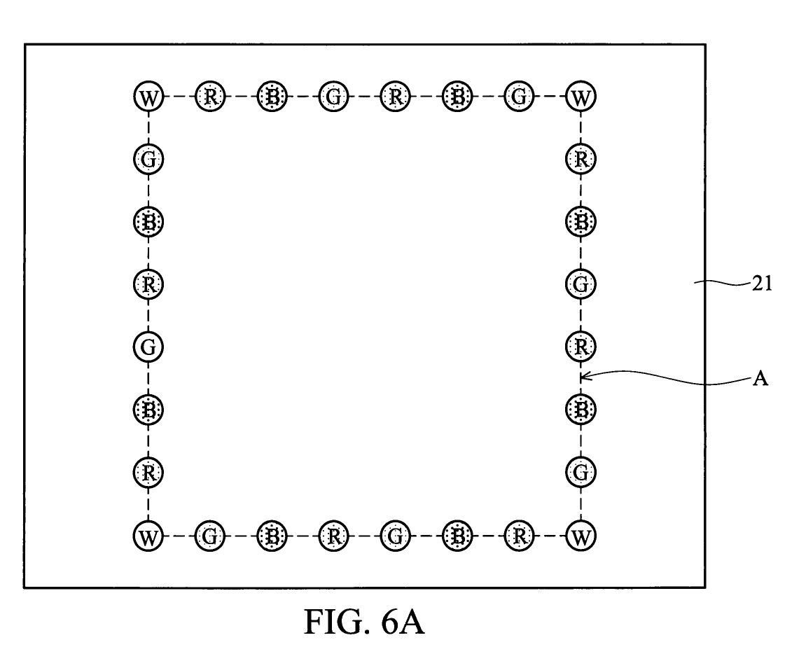

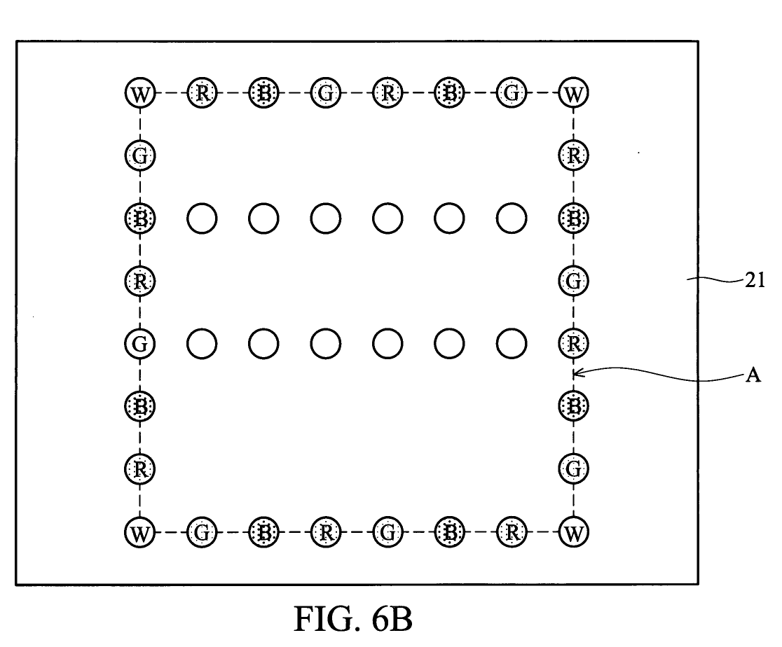

FIGS. 6A and 6B are schematic diagrams of an embodiment of a backlight module. In FIGS. 6A and 6B, the backlight module is a direct type backlight module. Descriptions of elements using the same reference numbers are omitted.

The red, blue, green and white LEDs R, B, G and W are disposed on the printed circuit board 21 to form a rectangular pattern, defining a rectangular light emitting area A. The white LEDs W are disposed at the corners of the light emitting area A. In other words, when viewing only one side of the rectangular pattern, which is identical to the other sides, the white LEDs W are disposed at each end of each side.

Referring to FIG. 6B, when the backlight module is large, except for the mentioned LEDs, rows of the LEDs may be employed in the light emitting area A, to increase overall brightness.

In some embodiments, in the light emitting area A, the red, blue, and green LEDs R, B and G are alternately arranged. Namely, the two adjacent LEDs have different colors, such that the blended light can be more uniformly.

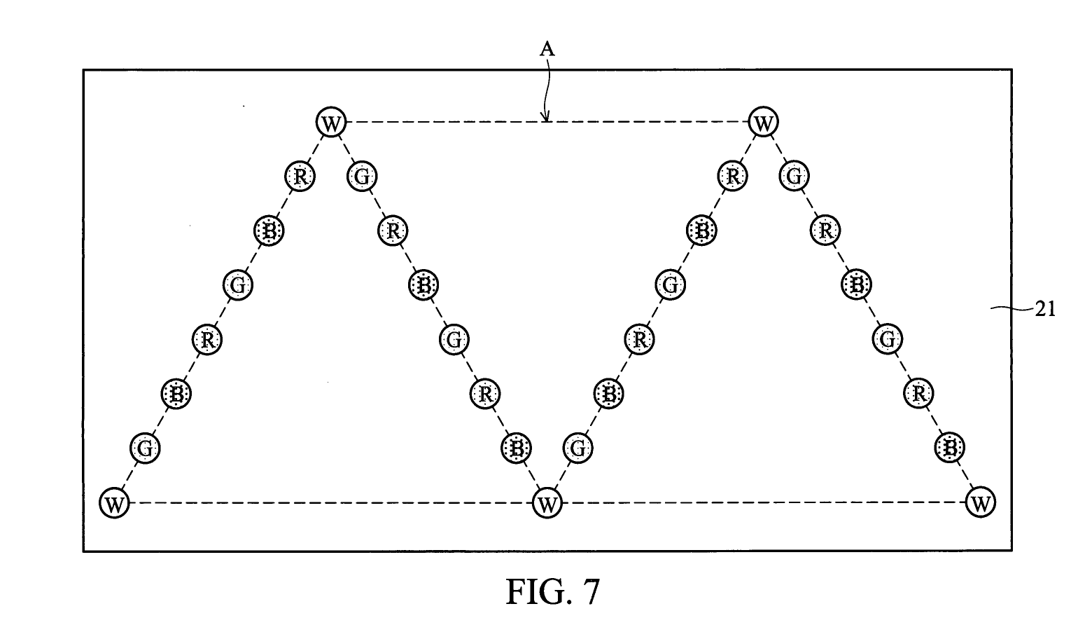

FIG. 7 is a schematic diagram of an embodiment of a backlight module. In FIG. 7, the backlight module is a direct type backlight module. Descriptions of elements using the same reference numbers are omitted.

The red, blue, green and white LEDs R, B, G and W are disposed on the printed circuit board 21 and arranged in a zigzag pattern, defining a light emitting area A. The white LEDs are disposed at the periphery of the light emitting area A. In other words, the white LEDs W are disposed at the points of the zigzag pattern.

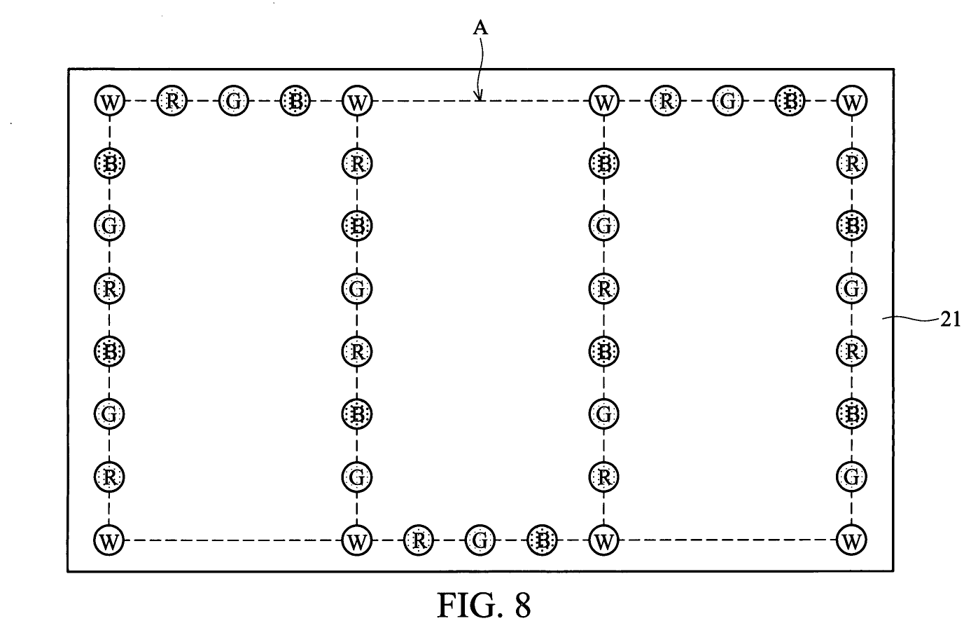

FIG. 8 is a schematic diagram of an embodiment of a backlight module. In FIG. 8, the backlight module is a direct type backlight module. Descriptions of elements using the same reference numbers are omitted.

The red, blue, green and white LEDs R, B, G and W are disposed on the printed circuit board 21 and arranged in a square-wave pattern, defining a light emitting area A. The white LEDs are disposed at the periphery of the light emitting area A. In other words, the white LEDs W are disposed at the outer extremities of the square-wave pattern.

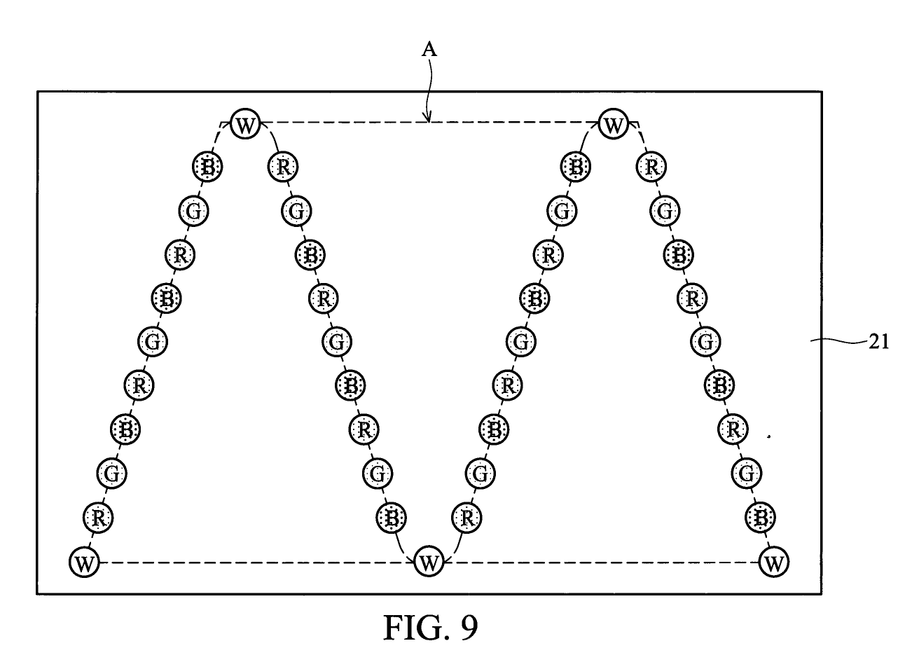

FIG. 9 is a schematic diagram of an embodiment of a backlight module. In FIG. 9, the backlight module is a direct type backlight module. Descriptions of elements using the same reference numbers are omitted.

The red, blue, green and white LEDs R, B, G and W are disposed on the printed circuit board 21 and arranged in a wave shape, defining a light emitting area A. The white LEDs are disposed at the periphery of the light emitting area A. In other words, the white LEDs W are disposed at the crests and the troughs of the wave shape.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module, comprising:
a printed circuit board;
a plurality of red light emitting diodes;
a plurality of blue light emitting diodes;
a plurality of green light emitting diodes; and
a plurality of white light emitting diodes,
wherein the plurality of red, blue, green and white light emitting diodes are disposed on the printed circuit board, defining a light emitting area, the plurality of white light emitting diodes is disposed at the periphery of the light emitting area.

2. The backlight module as claimed in claim 1, further comprising a reflector adjoined to the printed circuit board, reflecting the light from the plurality of red, blue, green and white light emitting diodes to form a planar light emitting surface.

3. The backlight module as claimed in claim 1, wherein the light emitting area is rectangular.

4. The backlight module as claimed in claim 3, wherein the plurality of white light emitting diodes is disposed at the corners of the light emitting area.

5. The backlight module as claimed in claim 1, wherein the red, blue and green light emitting diodes are alternating arrayed.

6. The backlight module as claimed in claim 1, wherein the plurality of red, blue, green and white light emitting diodes are arranged in a zigzag pattern with the white light emitting diodes disposed at the points thereof.

7. The backlight module as claimed in claim 1, wherein the plurality of red, blue, green and white light emitting diodes are arranged in a square-wave pattern with the white light emitting diodes disposed at the outer extremities thereof.

8. The backlight module as claimed in claim 1, wherein the plurality of red, blue, green and white light emitting diodes are arranged in a wave shape with the white light emitting diodes disposed at the crests and the troughs thereof.

9. A backlight module, comprising:
a printed circuit board;
a red light emitting diode;
a blue light emitting diode;
a green light emitting diode; and
a white light emitting diode,
wherein the red, blue, green and white light emitting diodes are disposed on the printed circuit board.

10. The backlight module as claimed in claim 9, further comprising a reflector adjoined to the printed circuit board, reflecting the light from the red, blue, green and white light emitting diodes to form a planar light emitting surface.

11. The backlight module as claimed in claim 9, wherein the red, blue, green and white light emitting diodes are disposed along a line, the white light emitting diode is disposed at an end of the line.

12. The backlight module as claimed in claim 9, wherein the white light emitting diode is disposed at an edge of the printed circuit board.

13. The backlight module as claimed in claim 9, wherein the red, blue and green light emitting diodes are alternating arranged.

14. The backlight module as claimed in claim 9, further comprising a plurality of the red, blue, green and white light emitting diodes.

15. The backlight module as claimed in claim 14, wherein the numbers of the red, blue and green light emitting diodes are equal.

16. The backlight module as claimed in claim 14, wherein the plurality of red, blue, green and white light emitting diodes are disposed along a line and the red, blue and green light emitting diodes are alternating arranged.

17. The backlight module as claimed in claim 14, wherein the plurality of red, blue, green and white light emitting diodes are arranged in a zigzag pattern with the white light emitting diodes disposed at the points thereof.

18. The backlight module as claimed in claim 14, wherein the plurality of red, blue, green and white light emitting diodes are arranged in a square-wave pattern with the white light emitting diodes disposed at the outer extremities thereof.

19. The backlight module as claimed in claim 14, wherein the plurality of red, blue, green and white light emitting diodes are arranged in a wave shape with the white light emitting diodes disposed at the crests and the troughs thereof.

20. The backlight module as claimed in claim 14, wherein the plurality of white light emitting diodes is disposed at the periphery of the printed circuit board.
